(19) United States
(12) Patent Application Publication
(10) Pub. No.: US 2005/0136229 A1
(43) Pub. Date: Jun. 23, 2005

(54) Variable data heat transfer label, method of making and using same

(75) Inventors: William A. Baldwin, London (GB); Eric M. Sutton, Middlesex (GB); David E. Zurawski, Clarence Center, NY (US); David B. Vaughn, North Tonawanda, NY (US); Dennis D. O'Rell, Geneva, IL (US); Arthur J. Malin, Northbrook, IL (US)

Correspondence Address: Mitchell J. Weinstein;Welsh & Katz, Ltd., 22nd Floor, 120 S. Riverside Drive, Chicago, IL, 60606, US

(73) Assignee: Illinois Tool Works, Inc., Glenview, IL (US)

(21) Appl. No.: 10/855,823

(22) Filed: May 27, 2004

Related U.S. Application Data
(63) Continuation-in-part of application No. 10/742,297, filed on Dec. 19, 2003.

(51) Int. Cl. B42D 15/00

(52) U.S. Cl. 428/195.1

(57) ABSTRACT

A heat transfer label for application to an item includes a heat transferable substrate having a transparent window area, a carrier for carrying the substrate and a variable graphic component including printed indicia on the window area. The variable graphic component is printed separate from the application of the substrate to the carrier and on an opposing side of at least a portion of the substrate from the carrier. The variable graphic component is printed prior to application of the heat transfer label to the item.

### CROSS-REFERENCE TO RELATED APPLICATION DATA

The present application is a continuation in part of U.S. patent application Ser. No. 10/742,297, filed Dec. 19, 2003.

### BACKGROUND OF THE INVENTION

The present invention relates to indicia-containing labels. More particularly, the present invention relates to heat transfer labels containing variable data, which labels are applied to articles to provide unique markings, methods of making the labels and methods of using the labels.

Indicia and/or graphics-containing labels are in widespread use in most every industry. For example, labels are used in the garment industry to mark articles of clothing to identify the manufacturer, the size of the garment, to provide laundry instructions, composition of the fabric, manufacturing location information and the like. In such a marking, there is both fixed and variable data. The fixed data can include the manufacturer, manufacturing location and laundry instructions whereas the size of the garment and the composition of the fabric can be variable data.

Another market that uses labels is the durable goods market. In this market, labels may be used on, for example, hand held power tools. Such labels may include both fixed data, e.g., manufacturer's name and manufacturing location, and variable data, e.g., model number, serial number, and power (voltage and ampere) requirements.

One drawback to the use of individually printed labels (that is, labels with variable data) is that large inventories of completely finished pre-printed labels are needed at the manufacturing or packaging location. While this approach provides desirable information on an item-attached label, the large label inventory that is needed, in conjunction with the space necessary for storing such an inventory, makes this approach undesirable.

In addition, when such individualized or customized labels are used, they are maintained in large quantities in inventory. This increases the likelihood of label obsolescence. That is, there may well be a large quantity of completely finished labels in inventory when a product is changed or discontinued.

Accordingly, there is a need for a variable data heat transfer label that provides the flexibility to locally print variable, e.g., changeable data, immediately prior to applying the label to the item. Desirably, such a label includes some manner of fixed data and a transparent window in which the variable data is printed and through which the data is viewed when the label is affixed to an object or item.

### SUMMARY OF THE INVENTION

A heat transfer label for application to an item includes a heat transferable substrate having a transparent window area. The substrate is carried on a carrier. The window area can be completely or partially transparent.

A variable graphic component including printed indicia is printed on the window area. The variable graphic component is printed separate from and subsequent to the application of the substrate to the carrier, but prior to application of the heat transfer label to the item.

Such a variable data heat transfer label provides the flexibility to locally print variable or changeable data immediately prior to applying the label to the item. A present label includes some manner of fixed data and a window area in which the variable data is printed, and through which the variable data is viewed after application to the item.

A method for marking an item includes providing a carrier web, applying a heat transferable substrate having a transparent window area to the carrier web to form an elongated coated web, printing a variable graphic component on the window area, printed separate from the step of applying the substrate to the web to form an elongated strip of heat transferable labels, transversely slitting the elongated strip of labels to provide item applicable labels and transferring the item applicable labels to the item.

These and other features and advantages of the present invention will be readily apparent from the following detailed description, in conjunction with the claims.

### BRIEF DESCRIPTION OF THE DRAWINGS

The benefits and advantages of the present invention will become more readily apparent to those of ordinary skill in the relevant art after reviewing the following detailed description and accompanying drawings, wherein:

FIG. 1 is a schematic illustration of a master web having three rows of printed variable data heat transfer labels embodying the principles of the present invention, in which the labels are shown in one row having fixed graphics on top of the transparent window, in a second row having fixed graphics immediately adjacent to the window, and in a third row having no fixed graphics;

FIG. 2A illustrates a web having a single row of labels with both fixed graphics and variable data printed on top of the transparent windows;

FIG. 2B illustrates a web similar to that of FIG. 2A, except that the labels have only variable data printed on top of the transparent windows;

FIG. 3 shows an exemplary apparatus for printing variable data onto the labels;

FIG. 4 is a cross-sectional view of the label on the carrier web prior to application to an object;

FIG. 5A is a cross-sectional view of the label applied to an object in which the fixed and variable graphics are printed on top of the transparent window prior to application to the object;

FIG. 5B is a cross-sectional view of the label applied to an object in which the fixed graphics are printed adjacent to the transparent window and the variable graphics are printed on top of the transparent window prior to application to the object;

FIG. 5C is a cross-sectional view of the label applied to an object in which variable graphics are printed on top of the transparent window prior to application to the object;

FIG. 5D is a cross-sectional view of the label applied to an object in which fixed graphics are disposed below the transparent window and variable graphics are printed on or over the window area;

FIGS. 5E and 5F are plan views of an alternate embodiment of the label in which the window areas are formed as panes or islands of material on the carrier web; and

FIG. 6 is an illustration of an exemplary overall process for making and using (preparing for application and applying) the variable data labels of FIGS. 4 and 5A.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be understood that the title of this section of this specification, namely, “Detailed Description Of The Invention”, relates to a requirement of the United States Patent Office, and does not imply, nor should be inferred to limit the subject matter disclosed herein.

In the present disclosure, the terms article, item, object, and product are used interchangeably to describe something that is produced that has commercial value and is, for example, an item that is the subject of a commercial transaction.

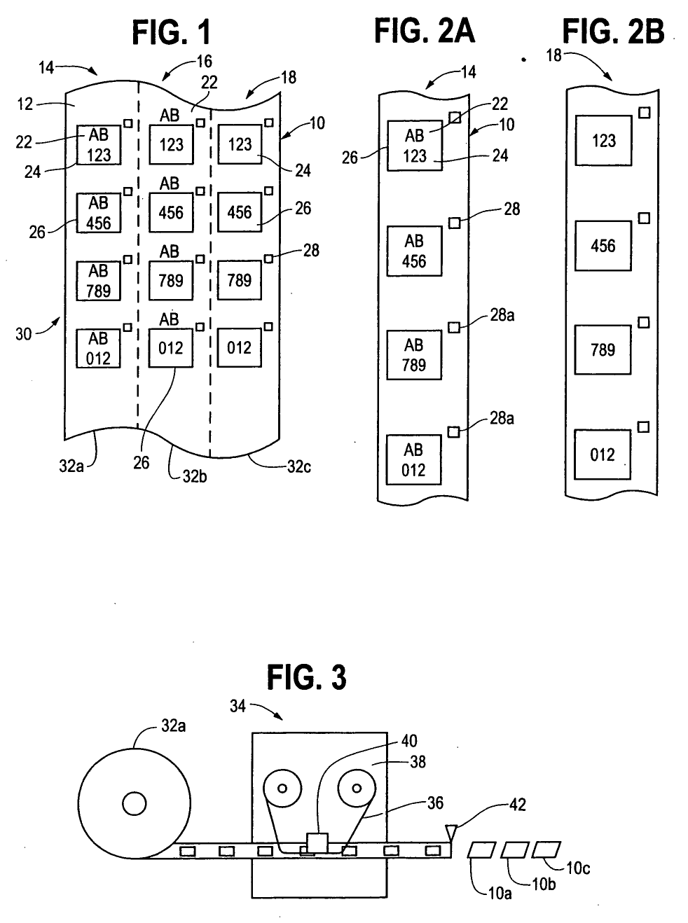

Referring now to the figures and briefly, to FIG. 1, there is shown one embodiment of a set of variable data heat transfer labels indicated generally at 10, embodying the principles of the present invention. In the illustrated embodiment, a carrier web 12 has three distinct rows 14, 16, 18 of discrete labels 10 on the carrier web 12. The discrete labels can be printed using a screen printing process; however, other processes can also be used including gravure, rotary screen, offset, or combinations of printing processes, for example, rotary screen and flexo, and the like.

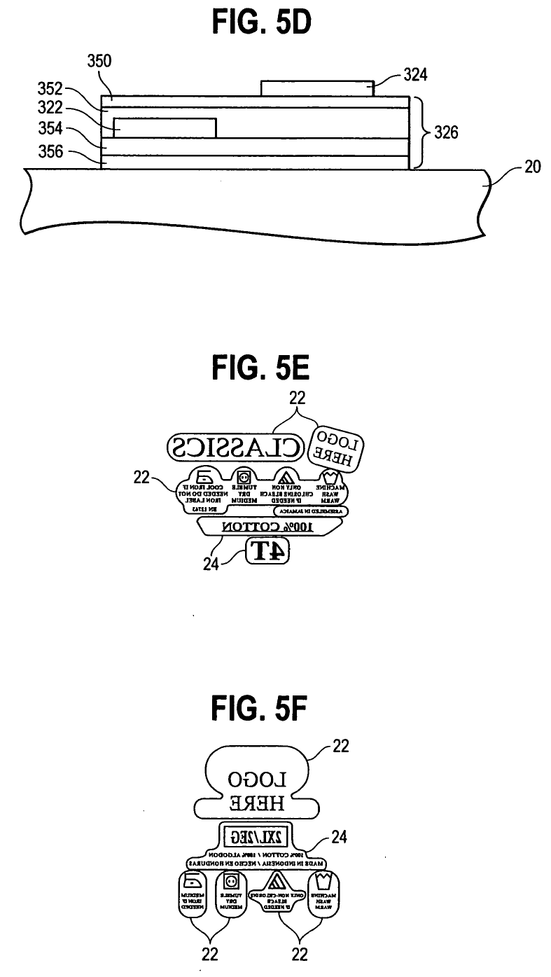

The present heat transfer labels 10 can be applied to an object (such as object 20 in FIG. 5A, which can be a “soft” item such as a fabric item of clothing or a “rigid” item, such a power tool) and provide a way in which the label 10 can contain both fixed data 22 and variable data 24. Such labels 10 allow a manufacturer to purchase rolls of heat transfer labels 10 with certain, desired fixed data 22 pre-printed and then print the appropriate labels with variable data 24 as need on-site. It will be understood that, as an example, the fixed data 22 is shown as alpha or letter characters in the figures and that the variable data 24 is shown as numeric characters in the figures.

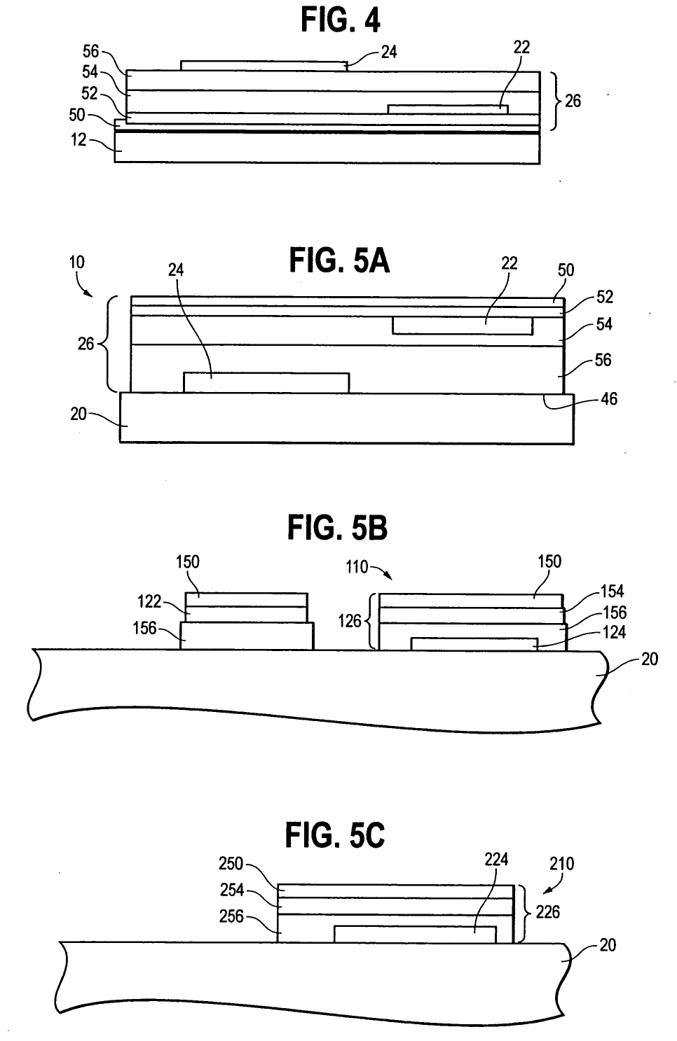

The carrier web 12 is typically a release-coated paper or plastic film. The release coating, indicated generally at 50 in FIG. 4, can be silicone based, or it can employ other release coatings that will be recognized by those skilled in the art. Typically, both sides of the carrier web have a release coating, and the release coatings will generally have different release characteristics. The printed side will typically have a tighter release than the non-printed side.

Each label 10 is formed with a transparent window area 26 and optionally fixed graphics 22. For purpose of the present disclosure, the term transparent means completely transparent, e.g., see-through, as well as partially transparent, e.g., translucent or capable of transmitting light to permit reading the imparted variable and/or fixed information through the window. Also for purposes of the present disclosure, the terms graphics, data and indicia are used interchangeably to indicate the fixed printing 22 of the label 10 or the variable printing 24 on the label 10. The fixed graphics 22 can vary depending on the object 20 that is being decorated with the label 10. For example, the labels 10 can include fixed data 22, such as a manufacturer's name, manufacturing location, logos, trademarks and the like.

If the object 20 has a rigid, e.g., plastic form, the window area 26 and fixed graphic 22 inks can be an acrylic, a vinyl, an epoxy, a polyester, a polystyrene or similar thermoplastic resin system. If the object is a fabric-based article, chemistries such as those disclosed in U.S. Pat. Nos. 4,256,795, 3,992,559 and 3,959,555 would be suitable for both the fixed graphics 22 and window area 26, which patents are incorporated herein by reference.

The entirety of the “printed” area forms the label 10. That is, the window 26 and the fixed graphics 22 (if used) that are printed on the web 12 constitute the label 10. In transferring the label 10 to the object 20, the adhesive layer 56 (shown as 156 in FIGS. 5B and 256 in FIG. 5C) on the label 10 softens and adheres to the object 20 by the application of heat and pressure.

Generally, the term “printing” connotes the application or transfer of colored or tinted indicia through the use of inks, dyes, pigments or the like. In the present label 10, the window 26 material is “printed” on the carrier web 12 without a pigment or tint, thus providing the characteristics of the transparent window area 26.

The fixed graphic 22 can be printed on top of or within the discrete window area 26 (as seen in row 14 in FIG. 1) or immediately adjacent to the window 26 (as seen in row 16). Alternately still, there may be situations where there is no need for fixed graphics at all, and in those cases, only a window area 26 is printed (as seen in row 18). It will also be appreciated that the window area 26 can be printed over the entirety of the carrier web 12, such that it essentially forms a continuous coating on the web 12.

In a preferred label 10, eye marks 28 are printed near the labels 10. These marks 28 can serve a variety of functions, such as providing a trigger for printing the variable graphic 24, for cutting the continuous roll of labels 10 into discrete single labels 10a,b,c (see FIG. 3) or for activating an application process, if, for example, the labels 10 are supplied to the application equipment in roll form. The eye marks 28 are not typically within the target label area in that the marks 28 are not generally transferred to the object 20.

In another embodiment of the preferred label 10, the eye marks 28 are printed in the form of a two dimensional bar code. The two dimensional bar code can be used to trigger the variable data printing process, to verify the authenticity of the label 10, to control the form, text, graphics, and the like of the variable data printed on the label 10, to control the position and timing of the cutting process to produce single labels 10a, 10b, 10c or to optionally control the application parameters (time, temperature and pressure) used in applying that label 10 to article 20. The two dimensional bar code can have a 2D Matrix Symbol that is commonly used in the industry, for example, as represented by DataMatrix, MaxiCode and QR Code.

In another variant of the label 10, the machine readable eye marks 28a (FIG. 2A) are printed within the transparent window area 26 using inks that are not visible under normal lighting conditions, but are readily detected under special conditions of lighting, for example, ultraviolet light, infra-red radiation, or electronic sensing, e.g., magnetic responsive inks. The machine readable eye marks may also be a component of the fixed graphics, through either graphic design parameters (such as shape, size, color contrast and the like), or the incorporation of special chemicals, including ultraviolet or infra-red active compounds, magnetic responsive inks, electrically activated luminescence, thermochromatic inks, photochromatic inks and the like.

Referring to FIG. 1, in a preferred form, a master roll 30 is slit down to yield individual rolls 32a,b,c (collectively 32) of material that are single width, i.e., rolls 32 having one row of labels 10. It is anticipated that rolls 32 in this single width form will be supplied to, for example, the article manufacturer.

The labels 10, as supplied, have the window area 26, the associated eye mark 28 and the optional fixed graphics 22. The fixed graphics 22 can be single or multiple color as desired by the article manufacturer.

The variable data 24 is printed on the window area 26 prior to applying the label 10 to the object 20. It is contemplated that the printing of variable data 24 will done at a different time and in a step separate from the printing of the fixed graphics 22 and window 26. In fact, it is anticipated that the variable data 24 will be printed at the article manufacturer's plant or at a nearby service facility using a variable data 24 printing process. The variable data 24 printing process can be carried out using ink jet, thermal transfer ribbon, ion printing and like printing processes.

FIG. 4 illustrates a cross-sectional view of one embodiment of the label 10 prior to application to an object. The carrier web 12, which can be supplied with a pre-coated release coating (not shown), is printed with a patterned release coat 50 followed by an optional clear coat 52. Preferably, the clear coat 52 is either a cross-linked material or a composition that has a melting point greater than about 300° F. to about 350° F. (about 150° C. to about 177° C.). The fixed graphics 22 are then printed on the clear coat layer. The fixed graphics 22 can be one or more layers or colors of inks as required to achieve the desired fixed graphics 22. The fixed graphics 22 can be in the form of letters, numbers, pictograms, logos or other unique graphic designs. The fixed graphics 22 are then over-coated with a layer of clear cross-linked or high melt point, i.e., melting point greater than about 350° F. (177° C.) material 54. This material layer 54 facilitates maintaining image definition during the application process. Without such an over-coat layer, the fixed graphics may become distorted during application to the article. A transparent or partially transparent adhesive layer 56 is printed over the cross-linked overcoat layer 54. The adhesive layer 56 provides good bonding (adhesion) between the label 10 and the object 20 and typically has a melting point less than about 250° F. to about 300° F. (about 120° C. to about 150° C.). The composition of the adhesive layer 56 will depend upon the chemical nature and structure of the article and the required performance characteristics of the label on the article. FIG. 5A, which is discussed in more detail below, illustrates that label of FIG. 4 as applied to an object 20.

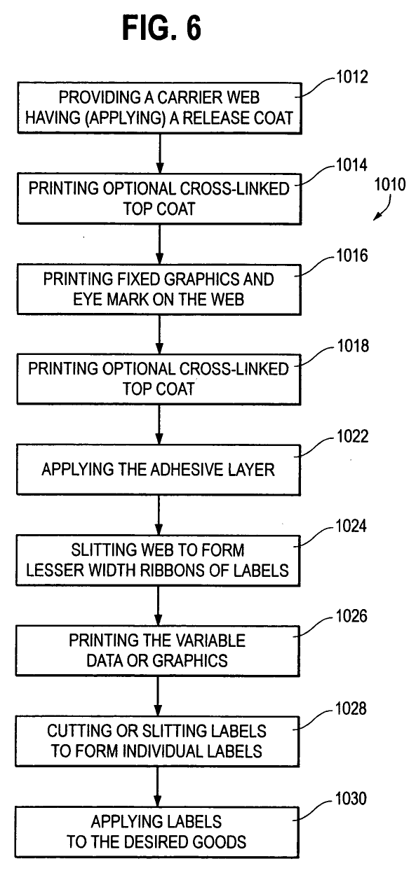

An exemplary work flow process 1010 is illustrated generally in FIG. 6. The exemplary work flow process represents the making and using of the label illustrated in FIGS. 4 and 5A. The work flow 1010 includes, as set forth above, providing a carrier web having a release coat applied thereto 1012. Alternately, and/or with the application of the release coat, the web can have a release coat pre-applied thereto. A typical carrier web will be a multiple width label. For example, the label can be three labels wide to facilitate certain of the process steps (e.g., printing).

The optional cross-linked top coat or high melt point composition can be applied to the release coat 1014. The top coat can be applied in a continuous manner, over the entirety of the web or in discrete regions on the web. Fixed graphics are then printed on the release coat or the optional top coat 1016. Eye marks are likewise printed along with the fixed graphics. A fixed graphic label is thus formed.

Following printing of the fixed graphics, optionally, a cross-linked clear layer or high melt point composition is applied over the fixed graphics 1018.

An adhesive layer is then applied over the cross-linked clear layer (if used) or over the fixed graphics 1022. The web is then slit to form lesser width labels 1024 (e.g., ribbons of labels), preferably single width labels, which are then fed into a printer to print the variable data or graphics 1026. An exemplary printer is commercially available from ITW Norwood of Downers Grove, Ill. under the trademark JAGUAR®. Following printing of the variable graphics, the individual labels are slit or cut 1028 and are applied to the desired goods 1030. Application of the labels to the goods or product can be carried out using, for example, a heat transfer press such as those commercially available from United Silicone, Inc., of Lancaster, N.Y.

This printing and application arrangement provides a number of advantages. First, in that the processes that require the completed labels (fully printed with both fixed and variable graphics) may require different quantities of labels, the variable data can be printed “as-needed” onto (fixed graphics) pre-printed labels. In addition, the variable graphics printing process is considerably faster (typically) than the transfer or application process. As such, the labels 10 can be printed on one printer, such as the JAGUAR® printer, and slit and distributed to a number of applicators, e.g., United Silicone, machines (for immediate or later use) to provide a cost effective and flexible process configuration. Other process configurations include having the printer and applicator integrated as taught in U.S. Pat. Nos. 5,813,772 and 5,658,647; however, in such an arrangement, the total capital (equipment) costs are higher.

FIG. 3 illustrates one exemplary apparatus 34 for printing the variable data 24 using a thermal transfer ribbon 36. In this process, a roll 32a of preprinted labels having a window area 26 and optionally fixed graphics 22 is fed into a variable data print unit printer 38. The variable graphics 24 are printed on to the window area 26 by a print head 40. As can be seen from FIG. 4, the variable graphics 24 are printed onto the adhesive layer 56, which covers (and forms part of) the window area 26. The patterned transfer of the coating from the ribbon 36 to the window area 26 forms the variable data 24 images. The labels 10 containing the variable data 24 are then either cut into individual labels 10a,b,c using a cutting mechanism 42, or are rewound onto another roll (not shown). The thermal transfer ribbon 36 may have different types of coatings. Common commercially available coatings include resin, resin-wax and wax based compositions. A preferred coating composition will depend upon the composition of the window area 26 and the performance requirements of the decorated object 20.

In an ink jet printing process (not shown), the variable information is printed on the window area 26 using liquid inks dispensed in a controlled pattern, e.g., as small ink droplets ejected from a computer controlled ink jet printing nozzle. The inks used in this process are aqueous or organic solvent based inks. Suitable organic solvents include, for example, ketones, alcohols, esters, or hydrocarbons. Preferred solvents are low boiling point compounds including ketones such as acetone and methyl ethyl ketone, alcohols such as ethanol, iso-propanol and n-propanol, esters such as ethyl acetate and n-propyl acetate, and hydrocarbons such as heptane and toluene. Other organic solvent based inks will be recognized by those skilled in the art.

In another embodiment of the invention, the variable data is printed using a hot stamping apparatus 34 that uses interchangeable dies and an appropriate heat transfer ribbon 36. This process can be used when the variable data 24 does not have to change on each successive heat transfer label 10. The interchangeable dies can have the required specific variable data, such as size code, fabric composition, manufacturing location, SKU, bar code, and the like, and the die could be changed as required to print the required quantity of heat transfer labels 10 for each specific product. In this fashion, varying quantities of heat transfer labels 10 could be produced to meet production needs. The thermal ribbon 36 used in this process is such as that commercially available from ITW Coding Products of Kalkaska, Mich., ITW Norwood Marking Systems of Downers Grove, Ill., and ITW FoilMark of Newburyport, Mass. The specific source and grade of hot stamping ribbon 36 used in the invention will depend on the composition of the transparent window 26, the chemical and physical nature of article 10 to which it is being applied and the end use performance requirements of article 10. Suitable hot stamping apparatus 34 and dies are available from United Silicone of Lancaster, N.Y.

The ink jet inks can also be radiation curable, such as those printed by an ink jet printer and cured by radiation, such as ultraviolet light, electron beam or infrared radiation. In a preferred process, the ink is cured after printing on the discrete window area 26 by exposing it to radiation from a suitable source. Radiation curing transforms the liquid ink into a solid form. Typically, such radiation curable inks provide good resistance to smearing.

Still another process (not shown) for printing the variable data is laser marking, in which the variable data is established by removing material from the discrete window areas. In one process, the window areas are over-printed with a solid layer of colored ink during the original (fixed) printing of the label. The labels are then marked with the variable data by exposing the label to a laser capable of generating the required marks. When the graphics are to be viewed in what is referred to as a positive format, the marking involves the ablation (removal) of the colored ink in the non-image areas associated with the variable data.

Conversely, when the variable data is to be viewed in a reverse format, the image is developed by laser marking or engraving the data into the colored ink printed on the discrete window areas. In this instance, the colored ink is removed (ablated) to generate the image and non-image areas are left unchanged on the window areas.

Regardless of the manner in which the variable data 24 is printed, it is anticipated that a variable data 24 printing unit in a stand-alone configuration or as part of the application process will be used at the article manufacturer's facility.

In the stand-alone configuration, the variable data printing unit (such as the printing apparatus 34 of FIG. 3) prints the labels 10 at a location remote to the application station and labels 10 are delivered to an application machine station in either roll form or as discrete, single piece labels. This process allows the article manufacturer to have a different number of variable data printers (generally fewer) as compared to the number of application machines. This also allows the variable data printer to be located in a central location within the facility to enhance security and provide better control of label inventory, both pre-printed and printed.

Alternately, the variable data printing unit can be associated with the application machine. In this configuration, a roll of pre-printed labels is mounted on the printer-application machine, the labels are transported through the variable data printing unit where the variable data is printed, and then the labels are advanced into the application section of the machine for application to the article. Such a concept is disclosed in U.S. Pat. Nos. 5,658,647 and 5,813,772. In a variation of this concept, the label could be applied to the article first and then the article with the applied label is advanced into the variable data printing unit where the variable data is printed on to the already applied label.

FIGS. 5A-5D illustrate various embodiments of labels 10, 110, 210, 310 as applied to objects 20. In FIG. 5A, the label 10 is applied to the object 20 at an exposed surface 46 of the label 10, such that the variable graphics 24 are in contact with the object 20 and are covered by the window 26 material. That is, the variable graphics 24 are sandwiched between the window 26 and the object 20. In this arrangement, the window 26 is formed from a composite or combination of the adhesive layer 56, the cross-linked clear layer 54, the split release coat 50, and optionally (as illustrated) the top clear layer 52. The fixed graphics 22 are applied to the optional cross-linked top coat 52 or the release coat 50, as desired and appropriate. It will be appreciated from the drawings that the label 10 of FIG. 4, which is shown on the carrier web 12 in that figure is the label 10 which is shown in FIG. 5A as applied to an object 20. This serves to protect the variable data 24, while maintaining the variable data 24 visible through the window 26.

In the label 110 of FIG. 5B, the variable graphics 124 are in contact with the object 20, and are covered by the entirely of the window 126 material which includes the adhesive layer 156, the cross-linked clear coat layer 154 and the split release coat 150. The fixed graphics 122 are in contact with and between the adhesive layer 156 and the split release coat 150. In this arrangement, the variable graphics 124 and adhesive 156 are in direct contact with the object 20.

Alternately as seen in the label 210 of FIG. 5C, the label 210 does not contain fixed data and, consequently, only variable graphics 224 and the window 226 material are in contact with the object 20, with the window 226 overlying and protecting the variable data 224. In this arrangement, the window area is formed from the adhesive layer 256, the cross-linked clear coat layer 254 and the split release coat 250.

In another embodiment of the label 310, as seen in FIG. 5D, the fixed graphics 322 are disposed within the window area 326, which is formed from the adhesive layer 356, the cross-linked clear coat layer 354, an optional cross-linked clear layer 352 and the split release coat 350. In this arrangement, the fixed graphics 322 are disposed between the cross-linked clear coat layer 354 and the optional cross-linked clear layer 352, and the variable graphics are disposed on the split release coat 350.

In still another embodiment of the label 310, as seen in FIGS. 5E and 5F, the transparent window area 26 is not a single contiguous block area, but is formed from a group of islands or panes, hat can be discrete and “free standing” or can be connected through a series of contact points to create a chain of connected islands or panes. The exact form of the heat transfer label 10 will depend on the graphic content of the label and the desired use.

It will be appreciated that the labels of FIGS. 5B-5D are formed, on a carrier web, in a manner similar to the label 10 illustrated in FIG. 4, that is, is in a reversed order from that in which the respective labels 110, 210, 310 are shown applied to their respective objects 20.

All patents referred to herein, are hereby incorporated herein by reference, whether or not specifically done so within the text of this disclosure.

In the disclosures, the words “a” or “an” are to be taken to include both the singular and the plural. Conversely, any reference to plural items shall, where appropriate, include the singular.

From the foregoing it will be observed that numerous modification and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

1. A heat transfer label for application to an item, comprising:
a heat transferable substrate, the substrate including a transparent window area;
a carrier for carrying the substrate; and
a variable graphic component including printed indicia on the window area, the variable graphic component being printed separate from the application of the substrate to the carrier and on an opposing side of at least a portion of the substrate from the carrier, the variable graphic component being printed prior to application of the heat transfer label to the item.

2. The heat transfer label in accordance with claim 1 wherein the window area is completely transparent.

3. The heat transfer label in accordance with claim 1 wherein the window area is partially transparent.

4. The heat transfer label in accordance with claim 1 including a fixed graphic component having printed indicia on or adjacent the window area, the fixed graphic component being formed prior to printing the variable graphic component.

5. The heat transfer label in accordance with claim 4 wherein the fixed graphic component is printed at least in part within the window area.

6. The heat transfer label in accordance with claim 4 wherein the fixed graphic component is printed at least in part outside of the window area.

7. The heat transfer label in accordance with claim 1 including a fixed graphic component having printed indicia below the window area.

8. The heat transfer label in accordance with claim 1 including multiple sets of fixed graphics printed on or adjacent the window area, the fixed graphic component being formed prior to printing the variable graphic component.

9. The heat transfer label in accordance with claim 1 including multiple sets of fixed graphics printed below the window area.

10. The heat transfer label in accordance with claim 1 wherein the heat transferable substrate is applied to the carrier web as a continuous member on the web.

11. The heat transfer label in accordance with claim 1 wherein the heat transferable substrate is applied to the carrier web as a plurality of discrete regions formed on the web.

12. The heat transfer label in accordance with claim 1 wherein a plurality of heat transfer labels are disposed on the carrier web.

13. The heat transfer label in accordance with claim 12 wherein the variable graphic component varies from a first label to an adjacent label.

14. A heat transfer label for application to an item, comprising:
a heat transferable substrate, the substrate including a transparent window area, the transparent window area formed from a plurality of layers;
a carrier for carrying the substrate; and
a variable graphic component including printed indicia on the window area, the variable graphic component being printed separate from the application of the substrate to the carrier and on an opposing side of the substrate from the carrier, the variable graphic component being printed prior to application of the heat transfer label to the item.

15. The heat transfer label in accordance with claim 14 wherein the window area includes an adhesive and wherein the variable graphic component is printed on the adhesive such that the variable graphic component is between the adhesive and the item when the label is applied to the item.

16. The heat transfer label in accordance with claim 14 including a fixed graphic component.

17. The heat transfer label in accordance with claim 16 wherein the fixed component is printed within the window area.

18. The heat transfer label in accordance with claim 15 wherein the window area is formed from a release coat layer, a cross-linked clear coat layer, and an adhesive.

19. The heat transfer label in accordance with claim 18 wherein a fixed graphic is disposed adjacent the cross-linked clear coat layer.

20. The heat transfer label in accordance with claim 18 including a cross-linked top coat layer disposed between the release coat and the cross-linked clear coat layer.

21. The heat transfer label in accordance with claim 20 including a fixed graphic disposed between the cross-linked clear coat layer and the cross-linked top coat layer.

22. The heat transfer label in accordance with claim 15 wherein the window area is formed from a release coat layer, a high melt point polymer clear coat layer, and an adhesive.

23. The heat transfer label in accordance with claim 22 wherein a fixed graphic is disposed adjacent the high melt point polymer clear coat layer.

24. The heat transfer label in accordance with claim 22 including a cross-linked top coat layer disposed between the release coat and the high melt point polymer clear coat layer.

25. The heat transfer label in accordance with claim 24 including a fixed graphic disposed between the high melt point polymer clear coat layer and the cross-linked top coat layer.

26. A method for marking an item comprising the steps of:
providing a carrier web;
applying a heat transferable substrate having a transparent window area formed therein to the carrier web to form an elongated coated web;
printing a variable graphic component including printed indicia on the window area, printed separate from the step of applying the heat transferable substrate to the carrier web to form an elongated strip of heat transferable labels;
transversely slitting the elongated strip of heat transferable labels to provide item applicable labels; and
transferring the item applicable labels to the item.

27. The method in accordance with claim 26 wherein the transparent window area is completely transparent.

28. The method in accordance with claim 26 wherein the transparent window area is partially transparent.

29. The method in accordance with claim 26 including the step of printing a fixed graphic component on the window area prior to printing the variable graphic component.

30. The method in accordance with claim 29 including the step of printing a series of fixed graphic components on the window area and slitting the elongated strip in the elongated direction to form multiple strips of item applicable labels.

31. The method in accordance with claim 30 including the step of slitting the multiple strips of item applicable labels to form item applicable labels.

32. The method in accordance with claim 26 including the step of transferring the label to the item.

33. The method in accordance with claim 26 including the step of printing a fixed graphic component below the window area.

34. The method in accordance with claim 32 including positioning the label on the item with the web away from the item and applying heat to the web to transfer the label to the item.

35. The method in accordance with claim 26 wherein the fixed graphic component is printed at least in part within the window area.

36. The method in accordance with claim 26 wherein the fixed graphic component is printed at least in part outside of the window area.

37. The method in accordance with claim 26 wherein the variable graphic component varies from a first label to an adjacent label.

38. The method in accordance with claim 29 including printing the fixed graphic component at a first printer and printing the variable graphic component at a second printer.

39. The method in accordance with claim 38 wherein the first and second printers are different from one another.

40. The method in accordance with claim 39 including printing the fixed graphic component at the first printer at a first printing speed and printing the variable graphic component at the second printer at a second printing speed, the first and second printing speeds being different from one another.

41. The method in accordance with claim 40 wherein the step of printing the fixed graphic component is carried out prior to the step of printing the variable graphic component.

42. The method in accordance with claim 30 wherein the step of printing a series of fixed graphic components on the window area and slitting the elongated strip in the elongated direction to form multiple strips of item applicable labels is carried out following the printing of the fixed graphic component.

43. A method for marking an item comprising the steps of:
providing a carrier web;
applying a heat transferable substrate forming a transparent window area therein to the carrier web to form an elongated coated web;
printing a variable graphic component including printed indicia on the window area, printed separate from the step of applying the heat transferable substrate to the carrier web to form an elongated strip of heat transferable labels;
transversely slitting the elongated strip of heat transferable labels to provide item applicable labels; and
transferring the item applicable labels to the item.

44. The method in accordance with claim 43 wherein the transparent window area is formed as a plurality of layers of material.

45. The method in accordance with claim 44 wherein one or more of the layers are formed from a cross-linked polymer material.

46. The method in accordance with claim 44 including the step of printing a fixed graphic component on the label.

47. The method in accordance with claim 46 wherein the fixed graphic component is printed between layers of the plurality of layers.

48. The method in accordance with claim 46 including the step of positioning the elongated coated web on a printer for printing of the variable graphic component, the printer being different from a printer for printing the fixed graphic component.

49. The method in accordance with claim 43, wherein the printing of the variable graphic component is triggered by an eye mark.

50. The method in accordance with claim 49, wherein the printing of the variable graphic component is triggered by the eye mark, the eye mark being printed within the heat transfer label and being invisible under normal lighting conditions.

51. The method in accordance with claim 50, wherein the invisible eye mark is detected using ultraviolet light.

52. The method in accordance with claim 50, wherein the invisible eye mark is detected using infrared or red light sensors.

53. The method in accordance with claim 50, wherein the invisible eye mark is detected using a laser.

54. The method in accordance with claim 50, wherein the invisible eye mark is detected using a magnetic sensing device.

55. The method in accordance with claim 50, wherein the invisible eye mark is detected using a capacitance sensing device.

56. The method in accordance with claim 43, wherein the printing of the variable graphic component is triggered by a contrast in color within the heat transfer label.

57. The method in accordance with claim 43, wherein the printing of the variable graphic component is performed using a hot stamping process using interchangeable dies.
